(19) United States
(12) Patent Application Publication
(10) Pub. No.: US 2022/0311028 A1
(43) Pub. Date: Sep. 29, 2022

(54) FUEL CELL VEHICLE

(71) Applicant: HONDA MOTOR CO., LTD., TOKYO (JP)

(72) Inventors: Satoru KAWASE, TOKYO (JP); Akira YAMADA, TOKYO (JP)

(21) Appl. No.: 17/674,112

(22) Filed: Feb. 17, 2022

(30) Foreign Application Priority Data
Mar. 23, 2021 (JP) 2021-048131

(51) Int. Cl. H01M 8/04082; H01M 8/04119; H01M 8/2475; B60L 50/72

(52) U.S. Cl. CPC H01M 8/04201; H01M 8/04119; H01M 8/2475; B60L 50/72; H01M 2250/20

(57) ABSTRACT

A fuel cell vehicle includes a fuel cell stack, a fuel tank that stores fuel gas to be supplied to the fuel cell stack, a tank chamber that houses the fuel tank, a gas filling port that fills the fuel tank with fuel gas from outside of the vehicle, a filling lid box that includes a housing chamber and a lid member and is provided above the tank chamber, a fuel gas sensor that is arranged in the tank chamber, and a duct that allows the housing chamber and the tank chamber to communicate with each other.

### CROSS-REFERENCE TO RELATED APPLICATIONS

This application is based upon and claims the benefit of priority from Japanese Patent Application No. 2021-048131 filed on Mar. 23, 2021, the contents of which are incorporated herein by reference.

### BACKGROUND OF THE INVENTION

### Field of the Invention

The present invention relates to a fuel cell vehicle including a fuel tank and a fuel gas sensor.

### Description of the Related Art

In a fuel cell vehicle, for example, a fuel gas tank (hydrogen tank) is disposed at a rear part (trunk or under the floor) of a vehicle. A fuel cell vehicle has adopted various ideas to detect leakage of fuel gas. For example, a vehicle hydrogen detection device disclosed in JP 2010-020910 A includes a hydrogen sensor provided in the vicinity of a hydrogen filling port.

### SUMMARY OF THE INVENTION

In JP 2010-020910 A, the hydrogen sensor is disposed in the vicinity of the hydrogen filling port. Therefore, when hydrogen gas is filled, the hydrogen sensor may detect a minute hydrogen leakage from a filling nozzle of the gas filling station (hydrogen station). In this case, unnecessary notification is given to a user, and the user's convenience is impaired.

In view of the foregoing, it is desirable to avoid detection of leakage of fuel gas from the filling nozzle of the gas filling station during filling of the fuel gas. Further, it is desirable that leakage of the fuel gas from the gas filling port provided in the vehicle can be suitably detected.

An object of the present invention is to solve the aforementioned problem.

A fuel cell vehicle includes: a fuel cell stack; a fuel tank that stores fuel gas to be supplied to the fuel cell stack; a tank chamber that houses the fuel tank; a gas filling port that fills the fuel tank with the fuel gas from outside the vehicle; a filling lid box that includes a housing chamber that houses the gas filling port, and a lid member that is capable of opening and closing the housing chamber, and is provided above the tank chamber; a fuel gas sensor arranged in the tank chamber; and a duct that allows the housing chamber and the tank chamber to communicate with each other.

According to the fuel cell vehicle of the present invention, it is possible to avoid detection of leakage of the fuel gas from a filling nozzle of a gas filling station during filling of the fuel gas. Further, when fuel gas leaks from the gas filling port provided in the vehicle, the leakage of the gas can be suitably detected.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic plan view of a fuel cell vehicle according to an embodiment of the present invention.

FIG. 2 is an explanatory diagram of a main part of the fuel cell vehicle.

### DESCRIPTION OF THE INVENTION

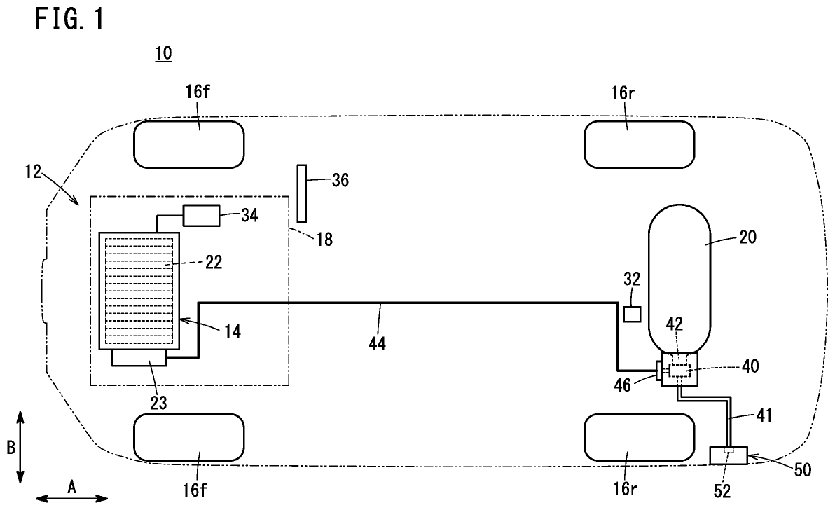

As shown in FIG. 1, a fuel cell vehicle 10 according to an embodiment of the present invention is equipped with a fuel cell system 12.

The fuel cell system 12 includes a fuel cell stack 14. The fuel cell stack 14 is disposed in a motor room 18 in the vicinity of front wheels 16f, 16f. In the fuel cell stack 14, a plurality of fuel cells 22 are stacked in the horizontal direction (arrow B direction) or the vertical direction.

Although not shown, the fuel cell 22 has, for example, a structure in which a membrane electrode assembly is sandwiched between a pair of separators. In the membrane electrode assembly, a cathode electrode is provided on one surface of a solid polymer electrolyte membrane. An anode electrode is provided on the other surface of the solid polymer electrolyte membrane. An oxygen-containing gas (e.g., air) is supplied to the cathode electrode. A fuel gas (e.g., hydrogen gas) is supplied to the anode electrode. As a result, electric power is generated through the electrochemical reaction between oxygen and hydrogen gas in the air. The fuel cell stack 14 is connected to a fuel gas supply device 23 that supplies the fuel gas, an air supply device (not shown) that supplies air, and a coolant supply device (not shown) that supplies coolant.

A fuel tank 20 is disposed between rear wheels 16r, 16r. Although only one fuel tank 20 is illustrated in FIG. 1, a plurality of fuel tanks 20 may be provided. When a plurality of fuel tanks 20 are provided, the capacities of the plurality of fuel tanks 20 may be different from each other.

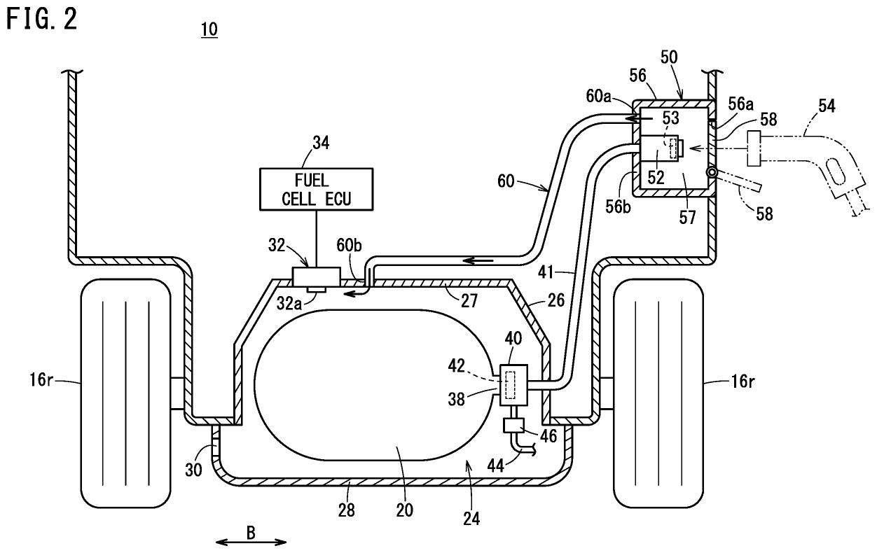

As shown in FIG. 2, the fuel tank 20 is disposed at a lower portion of the fuel cell vehicle 10. Specifically, the fuel tank 20 is housed in a tank chamber 24 provided at a lower portion of the fuel cell vehicle 10. The tank chamber 24 is formed by an under panel 26 and a cover 28 disposed below the under panel 26. The under panel 26 is a portion covering an upper portion of the fuel tank 20. The under panel 26 has a ceiling wall 27 facing the fuel tank 20 at a position above the fuel tank 20. The cover 28 covers a lower portion of the fuel tank 20. The cover 28 is provided with an opening 30 (or a gap) that allows the tank chamber 24 and the outside of the vehicle to communicate with each other.

The tank chamber 24 is provided with a fuel gas sensor 32. Specifically, the fuel gas sensor 32 is disposed (fixed) on the ceiling wall 27. The fuel gas sensor 32 detects leakage of the fuel gas and sends a detection signal to a fuel cell ECU 34. When the fuel gas sensor 32 detects leakage of the fuel gas, the fuel cell ECU 34 displays information on leakage of the fuel gas on a monitor 36 shown in FIG. 1. In this way, a user is notified of the leakage of the fuel gas.

The fuel tank 20 stores high-pressure fuel gas (e.g., hydrogen). An end portion of the fuel tank 20 has a fuel gas flow port 38. A fluid device 40 is connected to the fuel gas flow port 38. The fluid device 40 includes joints and valves including an on-off valve (main stop valve) 42.

For example, one end portion of the fuel gas supply pipe 44 is connected to the fluid device 40 through the joints. The other end of the fuel gas supply pipe 44 is connected to the fuel gas supply device 23 (see FIG. 1). The fuel gas supply pipe 44 is provided with a regulator 46 disposed near the fluid device 40.

One end of a fuel gas filling pipe 41 is connected to the fluid device 40. The other end portion of the fuel gas filling pipe 41 is connected to a gas filling port 52, which is an external connection port arranged in a filling lid box 50.

The gas filling port 52 is configured such that a filling nozzle 54 can be connected thereto in order to fill the fuel tank 20 with fuel gas from the outside of the fuel cell vehicle 10. In order to prevent the fuel gas from leaking out of the gas filling port 52, an airtight seal member 53 is provided inside the gas filling port 52. The filling nozzle 54 is installed in a gas filling station (hydrogen station). The filling nozzle 54 is manually (or automatically) connected to the gas filling port 52.

The filling lid box 50 is disposed above (at a higher position than) the tank chamber 24. Therefore, the gas filling port 52 is disposed above the tank chamber 24. The filling lid box 50 includes a box body 56 having an opening 56a that receives the filling nozzle 54, and a lid member 58 that opens and closes the opening 56a of the box body 56. The interior space of the box body 56 defines a housing chamber 57 that houses the gas filling port 52. The box body 56 has a wall portion 56b located on the side opposite to the opening 56a (or the lid member 58 in a closed state). The gas filling port 52 is fixed to the wall portion 56b.

The lid member 58 can open and close the housing chamber 57 with respect to the outside of the vehicle. When the lid member 58 is closed, the accommodating chamber 57 is in a closed state or a semi-closed state. When a lid switch (not shown) is operated by a user, the lid member 58 is opened and closed.

The fuel cell vehicle 10 is further provided with a duct 60 that allows the housing chamber 57 of the filling lid box 50 and the tank chamber 24 to communicate with each other. The duct 60 is a pipe that guides the fuel gas from the housing chamber 57 to the tank chamber 24 when the fuel gas leaks from the filling nozzle 54 to the housing chamber 57. The duct 60 has a first end portion 60a connected to the filling lid box 50, and a second end portion 60b connected to the ceiling wall 27 of the tank chamber 24.

The first end portion 60a of the duct 60 is a gas inflow port and opens to the housing chamber 57 at a position above the gas filling port 52. Therefore, the first end portion 60a is positioned above the tank chamber 24. The duct 60 communicates with the housing chamber 57 at the first end portion 60a. The first end portion 60a of the duct 60 is disposed above the second end portion 60b. The first end portion 60a of the duct 60 is provided at the highest position of the duct 60.

The duct 60 communicates with the tank chamber 24 at the second end portion 60b. The second end portion 60b of the duct 60 is a gas outlet and is located at the lowest position of the duct 60. The second end portion 60b is disposed above the highest position of the fuel tank 20. The second end portion 60b is disposed at a position (near position) adjacent to the fuel gas sensor 32 (more specifically, a detection portion 32a of the fuel gas sensor 32). A horizontal distance between the second end portion 60b of the duct 60 and the detection portion 32a of the fuel gas sensor 32 is preferably, for example, 50 mm or less.

The operation of the fuel cell vehicle 10 constructed in this manner will be described below.

First, during operation of the fuel cell vehicle 10, as shown in FIG. 1, at the fuel gas supply device 23, the fuel gas derived from the fuel tank 20 is supplied to the fuel cell stack 14 through the regulator 46 and the fuel gas supply pipe 44. At an air supply device (not shown), air is supplied to the fuel cell stack 14 by an air pump or the like. At a coolant supply device (not shown), a coolant is supplied to the fuel cell stack 14 by a pump or the like.

As a result, at each fuel cell 22, fuel gas is supplied to the anode electrode, and air is supplied to the cathode electrode. Therefore, at the membrane electrode assembly, the fuel gas supplied to the anode electrode and the oxygen-containing gas (oxygen in the air) supplied to the cathode electrode are consumed through the electrochemical reaction in the electrode catalyst layer. This electrochemical reaction is accompanied by electric power generation. Thus, electric power is supplied to a driving motor (not shown), and the fuel cell vehicle 10 can travel.

The fuel gas sensor 32 is disposed in the tank chamber 24. Therefore, when fuel gas leaks from the fuel tank 20, the fuel gas sensor 32 detects the fuel gas. In this case, a signal of the fuel gas sensor 32 is transmitted to the fuel cell ECU 34, and the leak of the fuel gas is notified to the user via the monitor 36 or the like.

The fuel tank 20 is filled with the fuel gas at a gas filling station (hydrogen station).

In FIG. 2, when a lid switch (not shown) is operated by the user, the lid member 58 is opened (see the lid member 58 illustrated with virtual lines). When the filling nozzle 54 is connected to the gas filling port 52 in the filling lid box 50 by the user, the fuel gas is adjusted to a desired flow rate and supplied to the gas filling port 52. Therefore, the fuel gas passes through the fuel gas filling pipe 41 and is filled into the fuel tank 20 through the fluid device 40.

When the filling of the fuel tank 20 with the fuel gas is completed, the filling nozzle 54 is disengaged from the gas filling port 52 and is removed from the filling lid box 50. Thereafter, the lid member 58 is closed by a manual operation or automatic operation.

In this case, the fuel cell vehicle 10 has the following effects.

As described above, the fuel cell vehicle 10 includes the filling lid box 50 provided above the tank chamber 24 and having the housing chamber 57 that houses the gas filling port 52, the fuel gas sensor 32 arranged in the tank chamber 24, and the duct 60 that allows the housing chamber 57 and the tank chamber 24 to communicate with each other. According to this configuration, when fuel gas leaks from the gas filling port 52, the fuel gas is guided to the tank chamber 24 through the duct 60, and the leak of the fuel gas can be detected with the fuel gas sensor 32 arranged in the tank chamber 24. The details are as follows.

When the fuel cell vehicle 10 is traveling, a lower portion of the vehicle body undergoes negative pressure because of the running wind. Since the tank chamber 24 is provided with the opening 30 (or a gap), the tank chamber 24 also undergoes negative pressure while the vehicle is traveling. On the other hand, since the lid member 58 of the filling lid box 50 is closed when the vehicle is traveling, the inside (housing chamber 57) of the filling lid box 50 produces positive pressure because of leakage of the fuel gas from the gas filling port 52. Therefore, during the traveling of the fuel cell vehicle 10, the pressure in the tank chamber 24 becomes lower than the pressure in the housing chamber 57 (a pressure difference occurs). The housing chamber 57 and the tank chamber 24 are in a state of being connected to each other through the duct 60. Therefore, due to the pressure difference between the housing chamber 57 and the tank chamber 24, the fuel gas is drawn from the housing chamber 57 to the tank chamber 24. The fuel gas thus guided to the tank chamber 24 is detected by the fuel gas sensor 32 disposed in the tank chamber 24.

In this manner, when fuel gas leaks from the gas filling port 52, the tank chamber 24 at a lower portion of the vehicle becomes negative pressure because of the running wind. By utilizing this phenomenon, the fuel cell vehicle 10 draws fuel gas from the housing chamber 57 of the filling lid box 50 into the tank chamber 24 through the duct 60. As a result, the fuel gas leaked from the gas filling port 52 can certainly be led to the fuel gas sensor 32, whereby the leakage of the fuel gas can be detected.

Further, it is possible to detect fuel gas leaking from the gas filling port 52 without providing the fuel gas sensor 32 in the vicinity of the gas filling port 52. That is, whether fuel gas leaks from the fuel tank 20 or from the gas filling port 52, the leakage of fuel gas can be detected by the fuel gas sensor 32 disposed in the tank chamber 24. Therefore, it is not necessary to provide another fuel gas sensor in the vicinity of the gas filling port 52.

On the other hand, at the time of filling the fuel gas at the gas filling station, a small amount of fuel gas may leak from the filling nozzle 54 that is equipment of the gas filling station. However, the fuel gas (hydrogen gas) having low density and light weight moves upward and in addition, the lid member 58 is open. Therefore, the fuel gas does not flow into the tank chamber 24 through the duct 60 (or from outside the duct 60). Therefore, the fuel gas leaked from the filling nozzle 54 is not detected by the fuel gas sensor 32. Therefore, erroneous detection of leakage of fuel gas on the fuel cell vehicle 10 side can be prevented at the time of filling the fuel gas.

In a fuel cell vehicle 10, the tank chamber 24 has the ceiling wall 27. The duct 60 has the first end portion 60a connected to the filling lid box 50 and the second end portion 60b connected to the ceiling wall 27. With this configuration, the fuel gas that has leaked from the gas filling port 52 while the vehicle travels can be suitably guided to the tank chamber 24.

In the fuel cell vehicle 10, the first end portion 60a of the duct 60 opens to the housing chamber 57 at a position above the gas filling port 52. According to this configuration, while the vehicle is traveling, the fuel gas having leaked from the gas filling port 52 in the housing chamber 57 can be easily guided to the duct 60.

In the fuel cell vehicle 10, the fuel gas sensor 32 is disposed on the ceiling wall 27, and the second end portion 60b of the duct 60 is disposed at a position adjacent to the fuel gas sensor 32. According to this configuration, the second end portion 60b serving as the gas outlet of the duct 60 is disposed in the vicinity of the fuel gas sensor 32. Therefore, the fuel gas introduced into the tank chamber 24 through the duct 60 from the housing chamber 57 in which the gas filling port 52 is disposed can be suitably detected.

The above embodiments are summarized as follows.

The above embodiment discloses a fuel cell vehicle (10) comprising: a fuel cell stack (14); a fuel tank (20) that stores a fuel gas to be supplied to the fuel cell stack; a tank chamber (24) that houses the fuel tank; a gas filling port (52) that fills the fuel tank with the fuel gas from outside the vehicle; a filling lid box (50) that includes a housing chamber (57) that houses the gas filling port and a lid member (58) that is capable of opening and closing the containing chamber and is provided above the tank chamber (24); a fuel gas sensor (32) that is arranged in the tank chamber; and a duct (60) that allows the containing chamber and the tank chamber to communicate with each other.

In the fuel cell vehicle described above, the tank chamber includes a ceiling wall (27), and the duct includes a first end portion (60a) connected to the filling lid box and a second end portion (60b) connected to the ceiling wall.

In the fuel cell vehicle described above, the first end portion of the duct opens into the housing chamber at a position above the gas filling port.

In the fuel cell vehicle, the fuel gas sensor is disposed on the ceiling wall, and the second end portion of the duct is disposed at a position adjacent to the fuel gas sensor.

The present invention is not limited to the above-described embodiments, and various configurations can be adopted therein without departing from the essence and gist of the present invention.

What is claimed is:

1. A fuel cell vehicle comprising:
a fuel cell stack;
a fuel tank that stores fuel gas to be supplied to the fuel cell stack;
a tank chamber that houses the fuel tank;
a gas filling port that fills the fuel tank with the fuel gas from outside of the vehicle;
a filling lid box that includes
a housing chamber that houses the gas filling port, and
a lid member that is capable of opening and closing the housing chamber, and
is provided above the tank chamber;
a fuel gas sensor that is arranged in the tank chamber; and
a duct that allows the housing chamber and the tank chamber to communicate with each other.

2. The fuel cell vehicle according to claim 1, wherein:
the tank chamber includes a ceiling wall; and
the duct includes a first end portion connected to the filling lid box and a second end portion connected to the ceiling wall.

3. The fuel cell vehicle according to claim 2, wherein:
the first end portion of the duct opens to the housing chamber at a position above the gas filling port.

4. The fuel cell vehicle according to claim 2, wherein:
the fuel gas sensor is disposed on the ceiling wall; and
the second end portion of the duct is disposed adjacent the fuel gas sensor.
